(19) United States
(12) Patent Application Publication
(10) Pub. No.: US 2018/0135916 A1
(43) Pub. Date: May 17, 2018

(54) HEAT-EXCHANGING DEVICE

(71) Applicant: Panasonic Intellectual Property Management Co., Ltd., Osaka (JP)

(72) Inventors: ATSUSHI SUEYOSHI, Kanagawa (JP); KENTARO KURODA, Osaka (JP); YOSHITOSHI NODA, Kanagawa (JP)

(21) Appl. No.: 15/871,408

(22) Filed: Jan. 15, 2018

Related U.S. Application Data
(63) Continuation of application No. PCT/JP2016/003551, filed on Aug. 2, 2016.

(30) Foreign Application Priority Data
Aug. 5, 2015 (JP) 2015-155265

(51) Int. Cl. F28D 9/00; F28F 3/08; F25B 39/00

(52) U.S. Cl. CPC F28D 9/0093; F25B 39/022; F25B 39/00; F28F 3/08

(57) ABSTRACT

The condenser of the heat-exchanging device is provided with a flow passage through which a high-pressure refrigerant flows. The flow passage is structured by openings formed in the plurality of plates. Inside the flow passage, an inner pipe having an outer diameter smaller than the diameter of the openings is disposed. The part inside the flow passage but outside the inner pipe serves as a passage in which the refrigerant that has flown into the condenser flows, and the part inside the inner pipe serves as a passage in which the refrigerant that has passed through the component section flows.

### CROSS-REFERENCE TO RELATED APPLICATIONS

This application is a continuation of the PCT International Application No. PCT/JP2016/003551 filed on Aug. 2, 2016, which claims the benefit of foreign priority of Japanese patent application No. 2015-155265 filed on Aug. 5, 2015, the contents all of which are incorporated herein by reference.

### BACKGROUND

### 1. Technical Field

The present disclosure relates to a heat-exchanging device.

### 2. Description of the Related Art

A conventionally known heat-exchanging device, which is used for a heat-pump system, exchanges heat between a refrigerant and coolant.

For example, Japanese Patent Unexamined Publication No. 2013-119373 discloses a heat-exchanging device with a structure where a plate on which a refrigerant flows and a plate on which coolant flows are alternately stacked. According to the heat-exchanging device, a plurality of components (such as a condenser, a liquid tank, and an evaporator) is formed into an integral structure, thereby eliminating piping between the components, by which the heat-exchanging device has a compact structure and is easily assembled.

### SUMMARY

The heat-exchanging device of an aspect of the present disclosure has a plate-stacked section in which a plurality of plates is continuously stacked one on another. The plate-stacked section includes a condenser and a component section. The condenser has a structure where a refrigerant passage through which a high-pressure refrigerant flows and a heat-carrier passage through which a heat carrier that absorbs heat from the high-pressure refrigerant flows are stacked one on another between some plates of the plurality of plates. The component section has a structure where the refrigerant that has passed through the condenser flows between some plates of the plurality of plates or via some plates. In the condenser, openings respectively formed in the plurality of plates form a flow passage through which the refrigerant flows. Inside the flow passage, a first pipe having an outer diameter smaller than the diameter of each of the openings is disposed. The first pipe is disposed such that the refrigerant that has come into the condenser flows inside the flow passage but outside the first pipe and the refrigerant that has passed through the component section flows inside the first pipe.

According to the present disclosure, the heat-exchanging device formed of a plurality of plates stacked one on another enhances durability of the structure.

### BRIEF DESCRIPTION OF DRAWINGS

FIG. 1 is a block diagram showing a structure of a heat pump system in accordance with a first exemplary embodiment.

FIG. 2 is a perspective view showing the structure of the heat-exchanging device in accordance with the first exemplary embodiment.

FIG. 3 is an exploded perspective view showing the structure of the heat-exchanging device in accordance with the first exemplary embodiment.

FIG. 4 is a schematic view illustrating an internal structure of the heat-exchanging device in accordance with the first exemplary embodiment.

FIG. 5 is a schematic view illustrating an internal structure of a heat-exchanging device in accordance with a second exemplary embodiment.

FIG. 6 is a block diagram showing a structure of a heat pump system in accordance with a third exemplary embodiment.

FIG. 7 is a schematic view illustrating an internal structure of the heat-exchanging device in accordance with the third exemplary embodiment.

FIG. 8 is a block diagram showing a structure of a heat pump system in accordance with a fourth exemplary embodiment.

FIG. 9 is a schematic view illustrating an internal structure of the heat-exchanging device in accordance with the fourth exemplary embodiment.

FIG. 10 is a schematic view illustrating an internal structure of a heat-exchanging device in accordance with a fifth exemplary embodiment.

FIG. 11 is a perspective view showing a structure of a heat-exchanging device in accordance with a sixth exemplary embodiment.

FIG. 12 is an exploded perspective view showing the structure of the heat-exchanging device in accordance with the sixth exemplary embodiment.

FIG. 13 is a schematic view showing an internal structure of the heat-exchanging device in accordance with the sixth exemplary embodiment.

FIG. 14 is a schematic view showing an internal structure of a heat-exchanging device in accordance with a seventh exemplary embodiment.

FIG. 15 is a schematic view showing an internal structure of a heat-exchanging device in accordance with an eighth exemplary embodiment.

FIG. 16 is a schematic view showing an internal structure of a heat-exchanging device in accordance with a ninth exemplary embodiment.

### DETAILED DESCRIPTION OF PREFERRED EMBODIMENTS

Prior to describing exemplary embodiments of the present disclosure, problems in the device of the related art are described briefly. In the heat-exchanging device of a stacked structure formed of a plurality of plates, the following flow passages are formed: a flow passage through which a refrigerant flows in the vertically downward direction; a flow passage through which the refrigerant flows in the vertically upward direction; a flow passage through which coolant flows in the vertically downward direction; and a flow passage through which the coolant flows in the vertically upward direction.

Each of these flow passages is formed of a plurality of openings overlapped with each other and respectively formed in an end section of each plate. However, forming a plurality of openings lowers the strength of the plates, degrading durability of the heat-exchanging device.

The present disclosure targets on enhancing the durability of a heat-exchanging device of a stacked structure formed of a plurality of plates.

Hereinafter, an exemplary embodiment of the present disclosure is described in detail with reference to accompanying drawings.

### First Exemplary Embodiment

Hereinafter, a first exemplary embodiment according to the present disclosure is described.

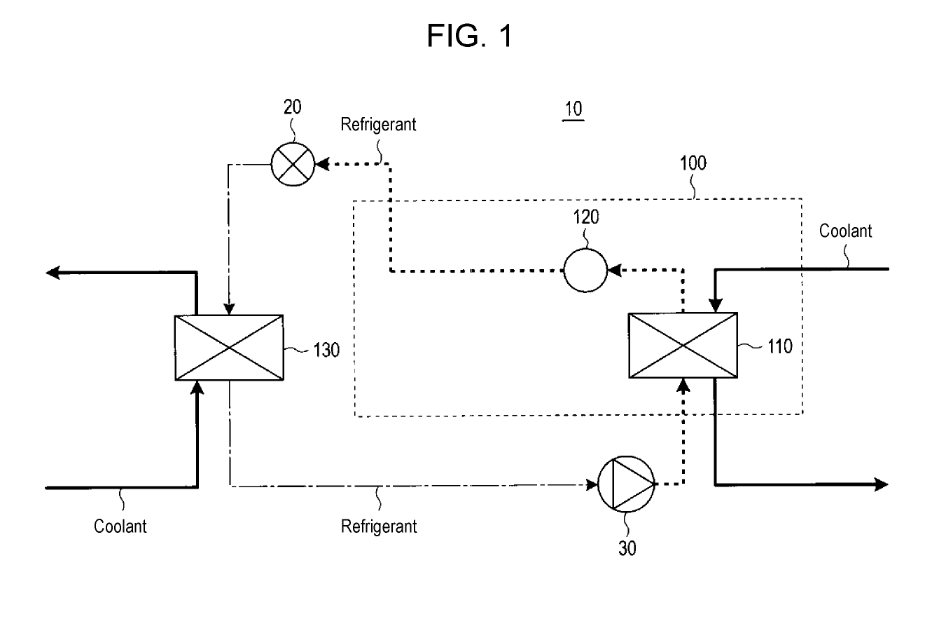

First, a structure of heat pump system 10 of the embodiment is described with reference to FIG. 1.

FIG. 1 is a block diagram showing the structure of heat pump system 10 of the embodiment.

Heat pump system 10 has condenser 110, liquid tank 120 (as an example of the component section), expansion valve 20, evaporator 130, and compressor 30. In heat pump system 10 shown in FIG. 1, heat-exchanging device 100 has an all-in-one structure, having condenser 110 and liquid tank 120 integrally.

Compressor 30 is disposed on the upstream side of an inlet for the refrigerant of condenser 110. Compressor 30 compresses the refrigerant sucked from evaporator 130 to change it into a high-temperature and high-pressure refrigerant and then feeds the refrigerant to condenser 110.

Condenser 110 performs heat exchange between coolant and the high-temperature and high-pressure refrigerant from compressor 30 to condense the refrigerant. The coolant is an anti-freezing solution for transferring heat, such as LLC (Long Life Coolant).

Liquid tank 120 retains the refrigerant fed from condenser 110, performs vapor-liquid separation on the refrigerant, and controls the amount of the refrigerant.

Expansion valve 20 is disposed on the upstream side of an inlet for the refrigerant of evaporator 130. Expansion valve 20 expands the refrigerant received from liquid tank 120 to change it into a low-temperature and low-pressure refrigerant and then feeds it to evaporator 130.

Evaporator 130 is disposed on the downstream side of expansion valve 20 and on the upstream side of compressor 30. Evaporator 130 performs heat exchange between the refrigerant fed from expansion valve 20 and the coolant to evaporate the refrigerant and then feeds the refrigerant to compressor 30.

Heat pump system 10 has the structure above.

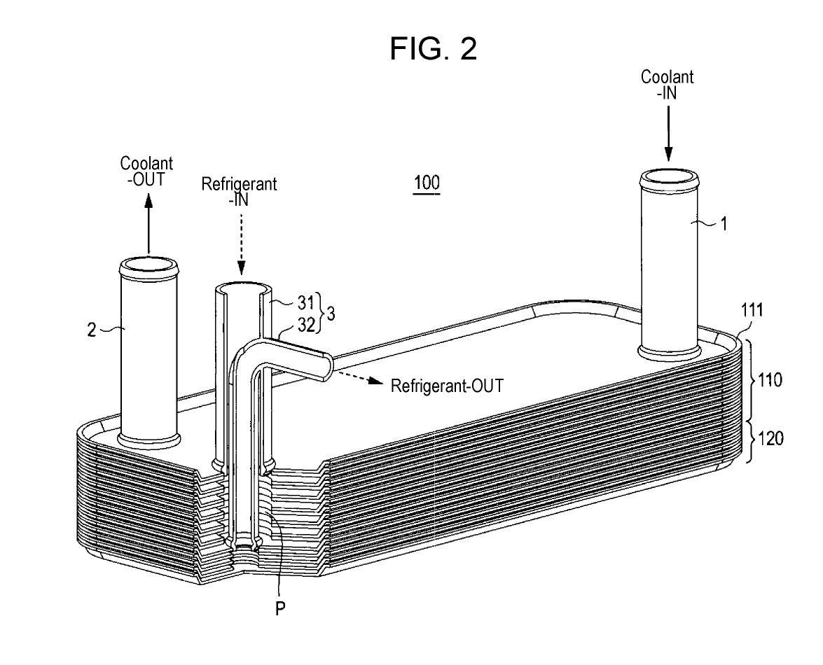

Next, the structure of heat-exchanging device 100 of the embodiment is described with reference to FIG. 2 through FIG. 4.

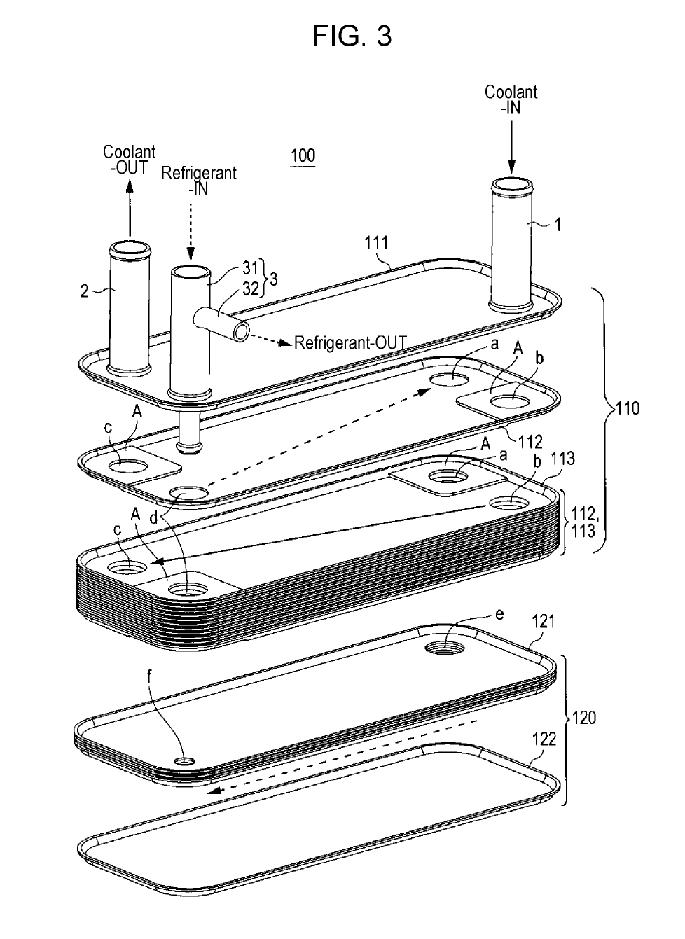

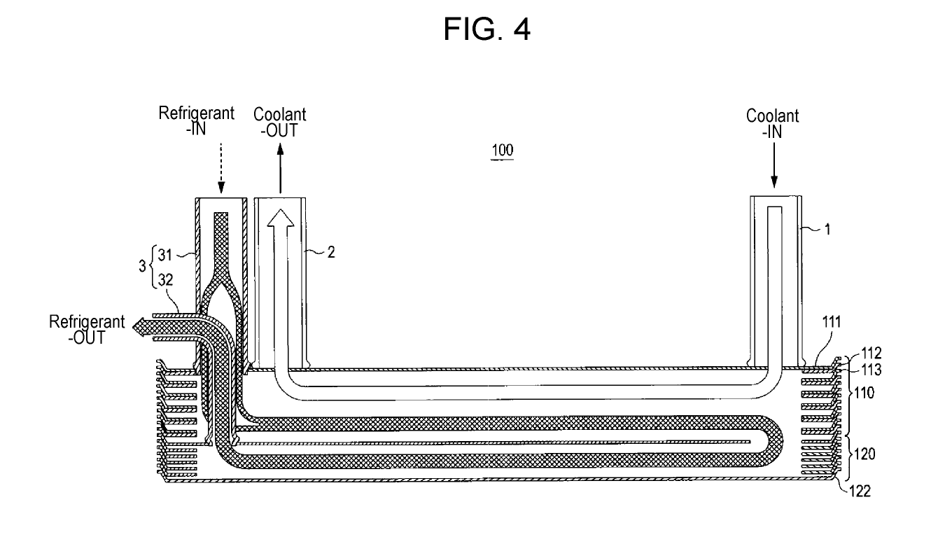

FIG. 2 is a perspective view showing the structure of heat-exchanging device 100 used for heat pump system 10 shown in FIG. 1. FIG. 2 shows a cross section of pipe 3. FIG. 3 is a perspective view showing a disassembled state of a plurality of plates forming heat-exchanging device 100 of FIG. 2. FIG. 4 is a cross-sectional view showing the structure of heat-exchanging device 100 of FIG. 2. FIG. 4 also shows flowing directions of the refrigerant and the coolant in heat-exchanging device 100. Apart of each plate is omitted in FIG. 4.

As shown in FIG. 2 and FIG. 3, heat-exchanging device 100 has a plate-stacked section formed of a plurality of plates continuously stacked one on another. Each of condenser 110 and liquid tank 120 is formed of some plates of the plurality of plates of the plate-stacked section. Specifically, condenser 110 is formed of condenser plates 111 through 113, and liquid tank 120 is formed of liquid-tank plates 121, 122.

The plurality of plates above is substantially equal in dimension in the stacking direction. That is, in heat-exchanging device 100, each of condenser plates 111 through 113 and each of liquid-tank plates 121, 122 are substantially equal in dimension in the stacking direction.

In addition, the plurality of plates above is equal in size and in outer shape. For example, each of condenser plates 111 through 113 is equal to each of liquid-tank plates 121, 122 in profile line and dimensions orthographically projected on a plane perpendicular to the stacking direction.

In heat-exchanging device 100, as shown in FIG. 2 through FIG. 4, pipe 1 and pipe 2 are connected to condenser plate 111. Pipe 1 feeds the coolant into condenser 110 and pipe 2 discharges the coolant having undergone heat exchange in condenser 110.

In heat-exchanging device 100, as shown in FIG. 2 through FIG. 4, pipe 3 is connected to condenser plate 111. Pipe 3 feeds high-temperature and high-pressure refrigerant compressed by compressor 30 into condenser 110. After heat exchange in condenser 110, the refrigerant undergoes vapor-liquid separation by liquid tank 120. Pipe 3 discharges the refrigerant after the vapor-liquid separation to expansion valve 20.

As shown in FIG. 2 through FIG. 4, pipe 3 has a double-pipe structure of outer-side pipe (hereinafter, outer pipe) 31 and inner-side pipe (hereinafter, inner pipe) 32. Outer pipe 31 is connected to opening ‘d’ of condenser plate 112. Inner pipe 32 is connected to openings ‘f’ of liquid-tank plates 121. Inner pipe 32 is connected to openings ‘f’ of liquid-tank plates 121. Inner pipe 32 runs through the inside of outer pipe 31 and protrudes from a side surface of outer pipe 31. Outer pipe 31 carries high-temperature and high-pressure refrigerant compressed by compressor 30 into condenser 110. After heat exchange in condenser 110, the refrigerant undergoes vapor-liquid separation by liquid tank 120. Inner pipe 32 discharges the refrigerant after the vapor-liquid separation to expansion valve 20.

Next, the structure of condenser 110 of the embodiment is described.

As shown in FIG. 3, condenser 110 has condenser plates 111 through 113 stacked one on another. Under condenser plate 111 to which pipes 1 through 3 are connected, condenser plate 112 and condenser plate 113, which are different in shape, are alternately stacked.

Condenser plate 112 is provided with openings ‘a’ through ‘d’ at its four corners. Bump section A is disposed around each of openings ‘b’ and ‘c’.

Condenser plate 113 is provided with openings ‘a’ through ‘d’ at its four corners. Bump section A is disposed around each of openings ‘a’ and ‘d’.

The alternately stacked structure of condenser plates 112, 113 alternately forms, between condenser plates 111 through 113, a refrigerant passage through which a high-pressure refrigerant flows and a coolant passage through which coolant for absorbing heat from the high-pressure refrigerant flows. The refrigerant and the coolant, without being mixed, flow through the refrigerant passage and the coolant passage, respectively. The refrigerant and the coolant flow the refrigerant passage and the coolant passage, respectively, in opposite directions from each other. In FIG. 3, the broken-line arrow shows the flowing direction of the refrigerant, and the solid-line arrow shows the flowing direction of the coolant.

In condenser 110, as described above, the refrigerant flows through the refrigerant passage and the coolant flows through the coolant passage, thereby the refrigerant and the coolant exchange heat therebetween, and the refrigerant is condensed.

In addition, the alternately stacked structure of condenser plates 112, 113 allows openings ‘a’ through ‘d’ to form the following flow passages.

A plurality of openings ‘b’ forms a flow passage through which the coolant coming from pipe 1 flows through condenser 110 in the vertically downward direction.

A plurality of openings ‘c’ forms a flow passage in which coolant that has passed the coolant passage flows through condenser 110 in the vertically upward direction. After that, the coolant is discharged from pipe 2.

A plurality of openings ‘a’ forms a flow passage in which refrigerant that has passed the refrigerant passage flows through condenser 110 in the vertically downward direction. The flow passage joins a flow passage formed of openings ‘e’ of liquid tank plates 121 (which will be described later). With the structure above, the refrigerant that has passed the refrigerant passage flows into liquid tank 120.

A plurality of openings ‘d’ forms flow passage P in which the refrigerant flows through condenser 110. In flow passage P, as shown in FIG. 2, inner pipe 32 having an outer diameter smaller than the diameter of opening ‘d’ (substantially the same as the inner diameter of outer pipe 31) is disposed. That is, flow passage P has a double-passage structure: one is the flow passage that runs inside flow passage P but outside inner pipe 32; and the other is the flow passage that runs inside inner pipe 32.

The flow passage, which runs inside flow passage P but outside inner pipe 32, serves as the flow passage in which the refrigerant fed from outer pipe 31 flows through condenser 110 in the vertically downward direction. The flow passage inside inner pipe 32 serves as the flow passage in which the refrigerant that has passed liquid tank 120 flows through condenser 110 in the vertically upward direction.

At the design phase of heat-exchanging device 100, the number of alternately stacked condenser plates 112, 113 determines the volume (efficiency in heat exchange) of condenser 110.

FIG. 3 and FIG. 4 show an example where the refrigerant and the coolant flow the refrigerant passage and the coolant passage, respectively, in opposite directions from each other, but it is not limited to; the refrigerant and the coolant may flow the refrigerant passage and the coolant passage, respectively, in the same direction.

Next, the structure of liquid tank 120 of the embodiment is described.

As shown in FIG. 3, liquid tank 120 has a plurality of liquid-tank plates 121 stacked one on another. At the bottom of liquid tank 120, liquid-tank plate 122 is disposed.

Each of the plurality of liquid-tank plates 121 is substantially equal to liquid-tank plate 122 in dimension in the stacking direction. Each of liquid-tank plates 121, 122 and each of condenser plates 111 through 113 are substantially equal in dimension in the stacking direction.

In addition, each of the plurality of liquid-tank plates 121 is substantially equal to liquid-tank plate 122 in size and in outer shape. Each of liquid-tank plates 121 and liquid-tank plate 122 are equal to each of condenser plates 111 through 113 in profile line and dimensions orthographically projected on a plane perpendicular to the stacking direction.

The plurality of liquid-tank plates 121 is continuously stacked together with and to be contact with the plurality of condenser plates 111 through 113. As shown in FIG. 2, liquid tank 120 is disposed under condenser 110.

Between adjacent two of the plurality of liquid-tank plates 121, the refrigerant passage in which the refrigerant fed from condenser 110 flows is formed.

As shown in FIG. 3, each of liquid-tank plates 121 has openings ‘e’, ‘f’ in two of the four corners. Opening ‘e’ is so formed that meets with the position of openings ‘a’ of condenser plates 112, 113. The diameter of opening ‘e’ is the same with that of opening ‘a’. Opening ‘f’ is so formed that meets with the position of openings ‘d’ of condenser plates 112, 113. The diameter of opening ‘f’ is the same with the inner diameter of inner pipe 32. Openings ‘e’, ‘f’ are not formed in liquid-tank plate 122.

The stacked structure of the plurality of liquid-tank plates 121 forms the following flow passages.

A plurality of openings ‘e’ forms the flow passage in which the refrigerant fed from condenser 110 flows through liquid tank 120 in the vertically downward direction. The flow passage, as described above, joins the flow passage formed of the plurality of openings ‘a’.

A plurality of openings ‘f’ forms the flow passage in which the refrigerant that has passed liquid tank 120 (i.e., the refrigerant passage between liquid-tank plates 121) flows through liquid tank 120 in the vertically upward direction. This flow passage joins the flow passage inside inner pipe 32, thereby the refrigerant that has passed liquid tank 120 is discharged from inner pipe 32 to expansion vale 20.

At the design phase of heat-exchanging device 100, the number of alternately stacked liquid-tank plates 121 determines the volume (capacity) of liquid tank 120.

Heat-exchanging device 100 is thus structured.

In heat-exchanging device 100 with the structure above, the coolant and the refrigerant flow as follows.

As shown in FIG. 4, the coolant fed from pipe 1 passes through condenser 110 and is discharged from pipe 2.

As shown in FIG. 4, the refrigerant, which has flown into outer pipe 31, flows through the inside of outer pipe 31 but the outside of inner pipe 32. After passing through condenser 110 and liquid tank 120, the refrigerant flows inside inner pipe 32 and is discharged from inner pipe 32 into expansion valve 20.

As described above, according to heat-exchanging device 100 of the embodiment, condenser 110 has flow passage P formed of a plurality of openings ‘d’ respectively formed in the plurality of condenser plates 111 through 113. A high-pressure refrigerant flows through flow passage P. Inside flow passage P, inner pipe 32 (as an example of the first pipe) having an outer diameter smaller than the diameter of opening ‘d’ is disposed. Inner pipe 32 is structured such that the refrigerant that has flown into condenser 110 flows inside flow passage P but outside inner pipe 32; at the same time, the refrigerant that has passed liquid tank 120 flows inside inner pipe 32.

In general, a heat-exchanging device having a condenser and a liquid tank has the following flow passages for refrigerant: a flow passage in which the refrigerant fed from the compressor flows through the condenser in the vertically downward direction; a flow passage in which the refrigerant that has passed the refrigerant passage of the condenser flows through the condenser and the liquid tank in the vertically downward direction; and a flow passage in which the refrigerant that has passed the refrigerant passage of the liquid tank flows through the condenser in the vertically upward direction. To form the three flow passages above, each plate has to be provided with three openings.

In contrast, according to the embodiment, inner pipe 32 is disposed in flow passage P formed of openings ‘d’. With the above structure, the refrigerant fed from the compressor flows inside flow passage P but outside inner pipe 32, and the refrigerant that has passed the refrigerant passage of the liquid tank flows inside inner pipe 32. The structure of the embodiment allows the openings, which are to be formed in each plate for forming the refrigerant passages, to be decreased to two: openings ‘a’ and ‘d’ for condenser plates 111 through 113; and openings ‘e’ and ‘f’ for liquid-tank plates 121.

According to the embodiment, the openings in each plate can be decreased in number, thereby ensuring strength of the plates. That is, the structure enhances durability of the heat-exchanging device.

As described above, the structure of the embodiment achieves decrease in number of the openings to be formed in each plate. When each opening is disposed in the short-side direction of the plate, as shown in FIG. 2 and FIG. 3, the structure allows the plate to have a decreased length of the short side, contributing to a downsized structure of a heat-exchanging device.

### Second Exemplary Embodiment

A second exemplary embodiment of the present disclosure is now described. The description of the first exemplary embodiment shows an example of a heat-exchanging device having the condenser and the liquid tank. The heat-exchanging device may further include an evaporator. The embodiment describes heat-exchanging device 101 having condenser 110, liquid tank 120, and evaporator 130 (as an example of the component section) in heat pump system 10 shown in FIG. 1.

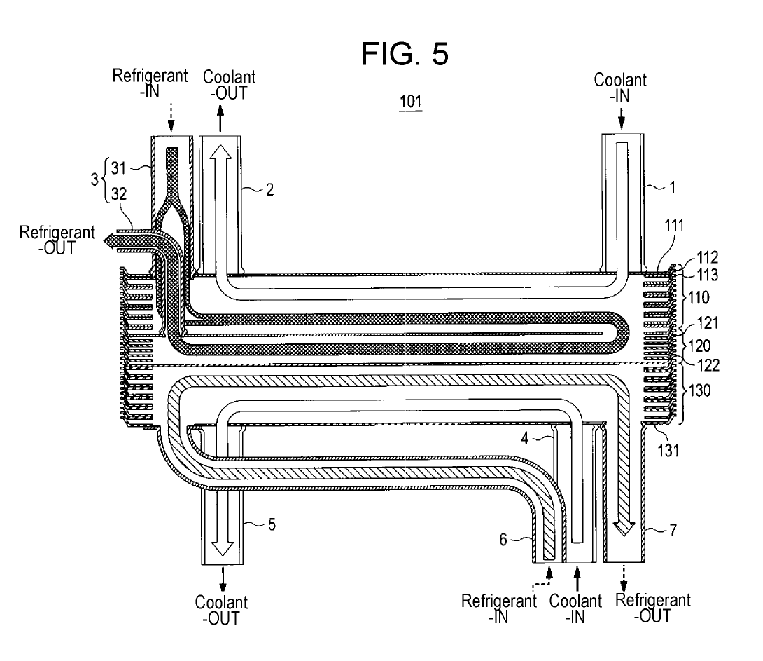

The structure of heat-exchanging device 101 of the embodiment is described with reference to FIG. 5.

FIG. 5 is a cross-sectional view showing the structure of heat-exchanging device 101 of the embodiment. FIG. 5 also shows a flowing direction of refrigerant and coolant in heat-exchanging device 101. Apart of each plate is omitted in FIG. 5. In FIG. 5, like parts are identified by the same reference marks as in FIG. 4, and the detailed description thereof is omitted.

As shown in FIG. 5, condenser 110 and liquid tank 120 in heat-exchanging device 101 are the same with the structure in the first exemplary embodiment.

As shown in FIG. 5, heat-exchanging device 101 has evaporator 130 under liquid tank 120. Evaporator 130 is formed of a plurality of evaporator plates 131 stacked one on another. Evaporator plates 131 are substantially equal in dimension in the stacking direction, and they are equal in size and in outer shape. Each of evaporator plates 131 is substantially equal to each of condenser plates 111 through 113 and each of liquid-tank plates 121, 122 in dimension in the stacking direction. In addition, each of evaporator plates 131 is substantially equal to each of condenser plates 111 through 113 and each of liquid-tank plates 121, 122 in profile line and dimensions orthographically projected on a plane perpendicular to the stacking direction.

As shown in FIG. 5, pipe 4 and pipe 5 are connected to the lowermost one of evaporator plates 131. Pipe 4 carries the coolant into evaporator 130 and pipe 5 discharges the coolant that has undergone heat exchange in evaporator 130. Further, pipe 6 and pipe 7 are connected to the lowermost one of evaporator plates 131. Pipe 6 carries the low-temperature and low-pressure refrigerant that has been expanded at expansion valve 20 into evaporator 130. Pipe 7 discharges the refrigerant that has undergone heat exchange in evaporator 130 into compressor 30.

The plurality of evaporator plates 131 is continuously stacked (with no space) under the plurality of condenser plates 111 through 113 and the plurality of liquid-tank plates 121, 122. Thus, evaporator 130 is disposed under liquid tank 120.

In evaporator 130, between adjacent two of the plurality of evaporator plates 131 stacked one on another, a refrigerant passage through which a low-pressure refrigerant flows and a coolant passage through which coolant that provides the low-pressure refrigerant with heat flows are stacked one on another. To be specific, differently-shaped evaporator plates 131 (for example, one is the same in shape with condenser plate 112, and the other is the same in shape with condenser plate 113) are alternately stacked. This allows the refrigerant passages and the coolant passages to be alternately formed between the plurality of evaporator plates 131. By virtue of the structure, the refrigerant and the coolant, without being mixed, flow the refrigerant passage and the coolant passage, respectively. The refrigerant and the coolant pass through the refrigerant passage and the coolant passage, respectively, in opposite directions from each other. In evaporator 130, as described above, the refrigerant flows through the refrigerant passage and the coolant flows through the coolant passage, thereby the refrigerant and the coolant exchange heat therebetween, and the refrigerant is evaporated.

At the design phase of heat-exchanging device 101, the number of differently-shaped evaporator plates 131 alternately stacked one on another determines the volume (efficiency in heat exchange) of evaporator 130.

FIG. 5 shows an example where the refrigerant and the coolant flow the refrigerant passage and the coolant passage, respectively, in opposite directions from each other, but it is not limited to; the refrigerant and the coolant may flow the refrigerant passage and the coolant passage, respectively, in the same direction.

Heat-exchanging device 101 is thus structured.

In heat-exchanging device 101 with the structure above, the coolant and the refrigerant flow as follows.

As shown in FIG. 5, the coolant fed from pipe 1 passes through condenser 110 and is discharged from pipe 2.

As shown in FIG. 5, the refrigerant, which has flown into outer pipe 31, flows through the inside of outer pipe 31 but the outside of inner pipe 32. After passing through condenser 110 and liquid tank 120, the refrigerant flows through the inside of inner pipe 32 and is discharged into expansion valve 20.

In addition, as shown in FIG. 5, the coolant fed from pipe 4 passes through evaporator 130 and is discharged from pipe 5.

As shown in FIG. 5, the refrigerant fed from pipe 6 passes through evaporator 130 and is discharged from pipe 7 into compressor 130.

Heat-exchanging device 101 of the embodiment, as described above, has condenser 110, liquid tank 120, and evaporator 130. Such structured heat-exchanging device 101 of the embodiment produces the effect similar to the structure described in the first exemplary embodiment.

### Third Exemplary Embodiment

A third exemplary embodiment of the present disclosure is described. The description of the second exemplary embodiment shows an example of the heat-exchanging device including the condenser, the liquid tank, and the evaporator. The heat-exchanging device may further include an intermediate heat-exchanger (IHX). The embodiment describes heat-exchanging device 102 including condenser 110, liquid tank 120, evaporator 130, and intermediate heat-exchanger 140 (as an example of the component section).

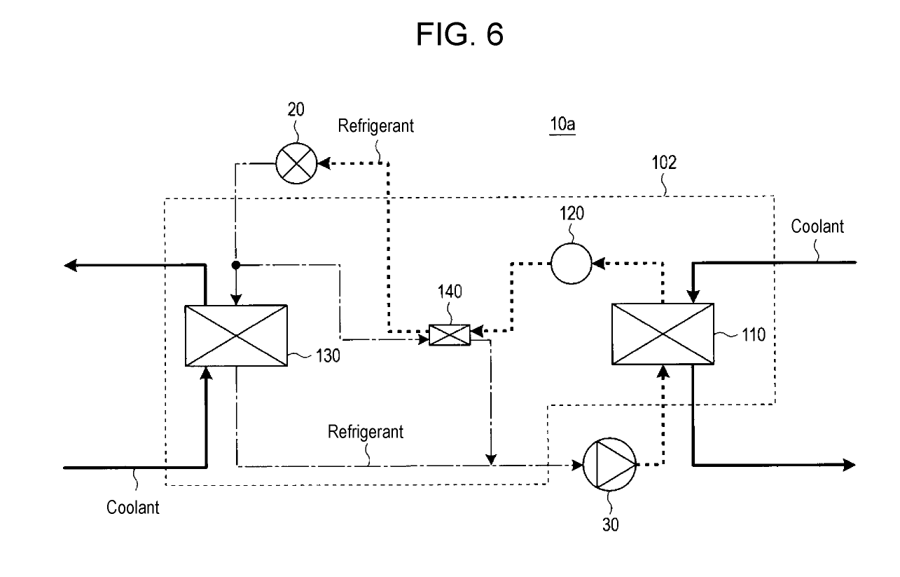

First, the structure of heat pump system 10a of the embodiment is described with reference to FIG. 6.

FIG. 6 is a block diagram showing the structure of heat pump system 10a of the embodiment. In FIG. 6, like parts are identified by the same reference marks as in FIG. 1, and the detailed description thereof is omitted.

Heat pump system 10a has heat-exchanging device 102, expansion valve 20, and compressor 30. Heat-exchanging device 102 has condenser 110, liquid tank 120, evaporator 130, and intermediate heat-exchanger 140.

Intermediate heat-exchanger 140 performs heat exchange between a high-temperature and high-pressure refrigerant fed from condenser 110 via liquid tank 120 (shown by the broken line) and a low-temperature and low-pressure refrigerant fed from expansion valve 20 (shown by the dashed-dotted line). After the heat exchange in intermediate heat-exchanger 140, the refrigerant that has been fed from condenser 110 via liquid tank 120 is discharged to expansion valve 20. Meanwhile, the refrigerant that has been fed from expansion valve 20 joins with the heat-exchanged refrigerant at evaporator 130 and is sucked into compressor 30. In this way, intermediate heat-exchanger 140 performs heat exchange between the high-temperature and high-pressure refrigerant fed from condenser 110 via liquid tank 120 and the low-temperature and low-pressure refrigerant fed from expansion valve 20.

Heat pump system 10a of the embodiment is thus structured.

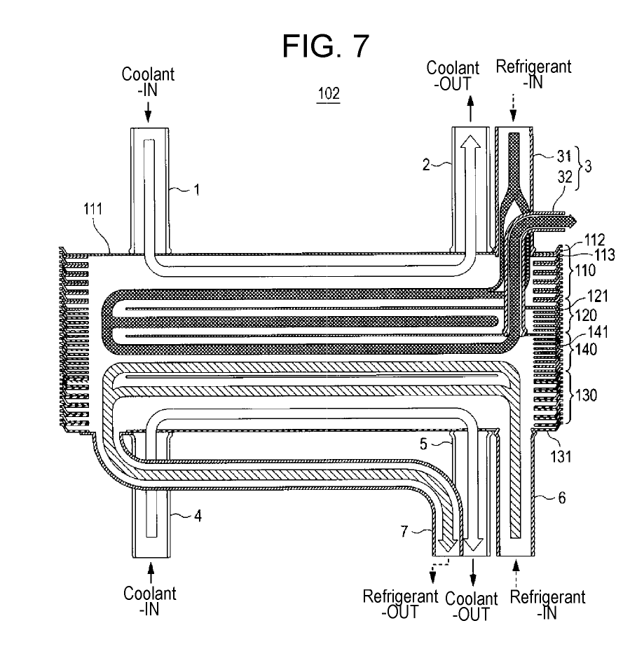

Next, the structure of heat-exchanging device 102 of the embodiment will be described with reference to FIG. 7.

FIG. 7 is a cross-sectional view showing the structure of heat-exchanging device 102 of the embodiment. FIG. 7 also shows flowing directions of the refrigerant and the coolant in heat-exchanging device 102. Apart of each plate is omitted in FIG. 7. In FIG. 7, like parts are identified by the same reference marks as in FIG. 5, and the detailed description thereof is omitted.

The structure of FIG. 7 differs from the structure of FIG. 5 in the followings: pipe 1 for feeding the coolant (coolant-IN) is oppositely disposed from pipe 2 for discharging the coolant (coolant-OUT) and pipe 3 for feeding and discharging the refrigerant (refrigerant-IN/OUT): pipe 4 for feeding the coolant (coolant-IN) is oppositely disposed from pipe 5 for discharging the coolant (coolant-OUT); and pipe 6 for feeding the refrigerant (refrigerant-IN) is oppositely disposed from pipe 7 for discharging the refrigerant (refrigerant-OUT).

As shown in FIG. 7, heat-exchanging device 102 has intermediate heat-exchanger 140 disposed at a position lower than liquid tank 120 and higher than evaporator 130. Intermediate heat-exchanger 140 is formed of a plurality of IHX plates 141 stacked one on another. The plurality of IHX plates 141 is substantially equal in dimension in the stacking direction and is equal in size and in outer shape. Each of the plurality of IHX plates 141 is substantially equal to each of condenser plates 111 through 113, each of liquid-tank plates 121, and each of evaporator plates 131 in dimension in the stacking direction. In addition, each of the plurality of IHX plates 141 is substantially equal to each of condenser plates 111 through 113, each of liquid-tank plates 121, 122, and each of evaporator plates 131 in profile line and dimensions orthographically projected on a plane perpendicular to the stacking direction.

The plurality of IHX plates 141 is continuously stacked with the plurality of condenser plates 111 through 113 and the plurality of liquid-tank plates 121, so that intermediate heat-exchanger 140 is located under liquid tank 120. Liquid tank 120 of the embodiment has no liquid-tank plate 122 shown in FIG. 3 at the bottom.

Similarly, the plurality of evaporator plates 131 is continuously stacked with the plurality of condenser plates 111 through 113, the plurality of liquid-tank plates 121, and the plurality of IHX plates 141, so that evaporator 130 is located under intermediate heat-exchanger 140.

Intermediate heat-exchanger 140 is structured such that first refrigerant-passages each in which a high-pressure refrigerant fed from condenser 110 flows and second refrigerant-passages each in which a low-pressure refrigerant fed from expansion valve 20 flows are disposed between the plurality of IHX plates 141 stacked one on another. Specifically, differently-shaped IHX plates 141 (for example, one is equal to condenser plate 112 in shape, and the other is equal to condenser plate 113 in shape) are alternately stacked, thereby the first refrigerant-passages and the second refrigerant-passages are alternately formed between the plurality of IHX plates 141. The refrigerant coming from condenser 110 and the refrigerant coming from expansion valve 20, without being mixed, pass through the first refrigerant-passage and the second refrigerant-passage, respectively. In addition, the refrigerant coming from condenser 110 and the refrigerant coming from expansion valve 20 pass through the first refrigerant-passage and the second refrigerant-passage, respectively, in opposite directions from each other. In intermediate heat-exchanger 140, as described above, the refrigerant fed from condenser 110 flows through the first refrigerant-passage and the refrigerant fed from expansion valve 20 flows through the second refrigerant-passage, thus the high-pressure refrigerant and the low-pressure refrigerant exchange heat therebetween.

As shown in FIG. 7, inner pipe 32 of the embodiment is connected to the opening where liquid tank 120 communicates with intermediate heat-exchanger 140 in liquid-tank plates 121. The structure allows the refrigerant that has passed the first refrigerant-passage of intermediate heat-exchanger 140 to be discharged from inner pipe 32 to expansion valve 20. Meanwhile, the refrigerant that has passed the second refrigerant-passage of intermediate heat-exchanger 140 joins the refrigerant coming from evaporator 130 and is discharged from pipe 7 to compressor 30.

At the design phase of heat-exchanging device 102, the number of differently-shaped IHX plates 141 to be alternately stacked determines the volume (efficiency in heat exchange) of intermediate heat-exchanger 140.

FIG. 7 shows an example where the refrigerant and the coolant flow the refrigerant passage and the coolant passage, respectively, in opposite directions from each other, but it is not limited to; the refrigerant and the coolant may flow the refrigerant passage and the coolant passage, respectively, in the same direction. Similarly, FIG. 7 shows an example where the refrigerant from condenser 110 and the refrigerant from expansion valve 20 pass through the first refrigerant-passage and the second refrigerant-passage, respectively, in opposite directions from each other, but it is not limited to; the refrigerant from condenser 110 and the refrigerant from expansion valve 20 may pass through the first refrigerant-passage and the second refrigerant-passage, respectively, in the same direction.

Heat-exchanging deice 102 is thus structured.

In heat-exchanging device 102 with the structure above, the coolant and the refrigerant flow as follows.

As shown in FIG. 7, the coolant fed from pipe 1 passes through condenser 110 and is discharged from pipe 2.

As shown in FIG. 7, the refrigerant, which has flown into outer pipe 31, flows through the inside of outer pipe 31 but the outside of inner pipe 32. After passing through condenser 110, the refrigerant branches into liquid tank 120 and intermediate heat-exchanger 140. The refrigerant that has passed intermediate heat-exchanger 140 flows through the inside of inner pipe 32 and is discharged from inner pipe 32 into expansion valve 20.

Besides, as shown in FIG. 7, the coolant fed from pipe 4 passes through evaporator 130 and is discharged from pipe 5.

As shown in FIG. 7, the refrigerant fed from pipe 6 branches into evaporator 130 and intermediate heat-exchanger 140. The refrigerant that has passed evaporator 130 and the refrigerant that has passed intermediate heat-exchanger 140 join again, and it is discharged from pipe 7 to compressor 30.

Heat-exchanging device 102 of the embodiment, as described above, has condenser 110, liquid tank 120, evaporator 130, and intermediate heat-exchanger 140. Such structured heat-exchanging device 102 of the embodiment produces the effect similar to the structure described in the first exemplary embodiment.

### Fourth Exemplary Embodiment

A fourth exemplary embodiment of the present disclosure is described. Although the third exemplary embodiment has described an example of a parallel structure where the refrigerant fed from the expansion valve branches in parallel into the intermediate heat-exchanger and the evaporator, the refrigerant from the expansion valve may flow into the intermediate heat-exchanger via the evaporator in series. The exemplary embodiment describes heat-exchanging device 103 with such a series structure in which the refrigerant fed from the expansion valve passes through the evaporator and flows into the intermediate heat-exchanger.

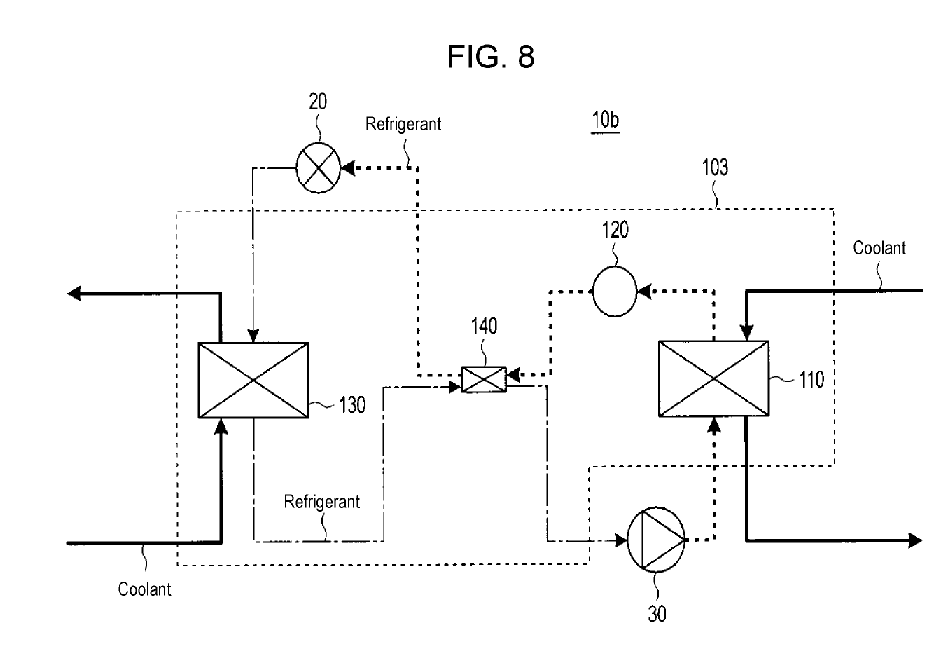

First, the structure of heat pump system 10b of the embodiment is described with reference to FIG. 8.

FIG. 8 is a block diagram showing the structure of heat pump system 10b of the embodiment. In FIG. 8, like parts are identified by the same reference marks as in FIG. 6, and the detailed description thereof is omitted.

Intermediate heat-exchanger 140 performs heat exchange between a high-temperature and high-pressure refrigerant fed from condenser 110 via liquid tank 120 (shown by the broken line) and low-temperature and a low-pressure refrigerant fed from evaporator 130 (shown by the dashed-dotted line). After the heat exchange in intermediate heat-exchanger 140, the refrigerant fed from condenser 110 via liquid tank 120 is discharged to expansion valve 20. Meanwhile, the refrigerant fed from evaporator 130 is sucked into compressor 30. In this way, intermediate heat-exchanger 140 performs heat exchange between the high-temperature and high-pressure refrigerant fed from condenser 110 and the low-temperature and low-pressure refrigerant fed from expansion valve 20.

Heat pump system 10b of the embodiment is thus structured.

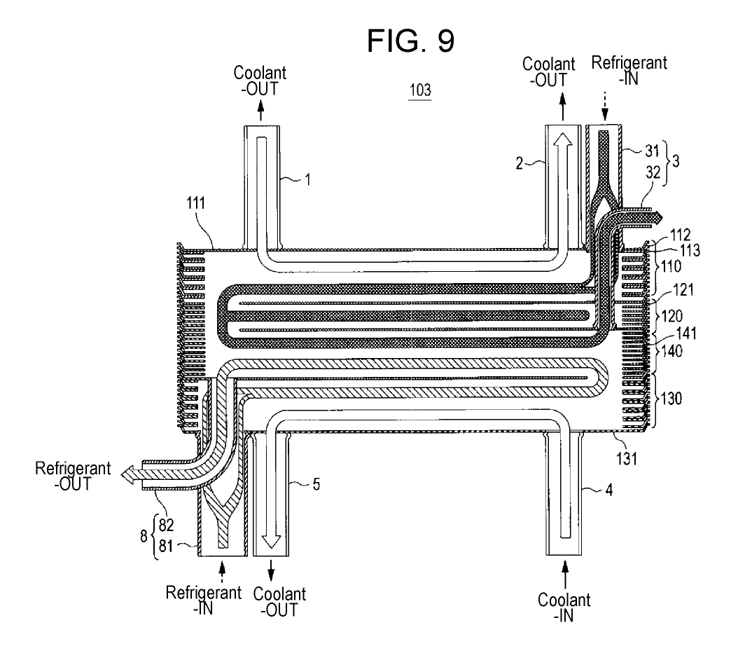

Next, the structure of heat-exchanging device 103 of the embodiment is described with reference to FIG. 9.

FIG. 9 is a cross-sectional view showing the structure of heat-exchanging device 103 of the embodiment. FIG. 9 also shows flowing directions of the refrigerant and the coolant in heat-exchanging device 103. Apart of each plate is omitted in FIG. 9. In FIG. 9, like parts are identified by the same reference marks as in FIG. 7, and the detailed description thereof is omitted.

As shown in FIG. 9, pipe 4 for refrigerant-IN, pipe 5 for coolant-OUT, and pipe 8 for refrigerant-IN/OUT are connected to the lowermost plate of evaporator plates 131 of evaporator 130. Like pipe 3, pipe 8 has a double-pipe structure of outer pipe 81 and inner pipe 82. The inner diameter of outer pipe 81 is greater than the outer diameter of inner pipe 82.

Inner pipe 82 is connected to the openings formed in IHX plates 141. The openings connect intermediate heat-exchanger 140 with evaporator 130. Inner pipe 82 runs through the inside of outer pipe 81 and protrudes from a side surface of outer pipe 81. Outer pipe 81 carries the low-temperature and low-pressure refrigerant expanded by expansion valve 20 into evaporator 130. Inner pipe 82 discharges the refrigerant having undergone heat exchange in intermediate heat-exchanger 140 to compressor 30.

As shown in FIG. 9, the part that is the inside of outer pipe 81 but is the outside of inner pipe 82 serves as a flow passage in which the refrigerant that has flown into evaporator 130 flows through evaporator 130 in the vertically upward direction. As shown in FIG. 9, the inside of inner pipe 82 serves as a flow passage in which the refrigerant that has passed intermediate heat-exchanger 140 flows through evaporator 130 in the vertically downward direction.

Heat-exchanging device 103 is thus structured.

In heat-exchanging device 103 with the structure above, the coolant and the refrigerant flow as follows.

As shown in FIG. 9, the coolant fed from pipe 1 passes through condenser 110 and is discharged from pipe 2.

As shown in FIG. 9, the refrigerant, which has flown from outer pipe 31, flows through the inside of outer pipe 31 but the outside of inner pipe 32. After passing through condenser 110, the refrigerant branches into liquid tank 120 and intermediate heat-exchanger 140. The refrigerant that has passed through intermediate heat-exchanger 140 flows through the inside of inner pipe 32 and is discharged from pipe 32 to expansion valve 20.

As shown in FIG. 9, the coolant fed from pipe 4 passes through evaporator 130 and is discharged from pipe 5.

As shown in FIG. 9, the refrigerant fed from outer pipe 81 runs through the inside of outer pipe 81 but the outside of inner pipe 82. After passing through evaporator 130, the refrigerant flows into intermediate heat-exchanger 140. After passing through intermediate heat-exchanger 140, the refrigerant flows through the inside of inner pipe 82 and is discharged from inner pipe 82 to compressor 130.

Heat-exchanging device 103 of the embodiment, as described above, has condenser 110, liquid tank 120, evaporator 130, and intermediate heat-exchanger 140. Such structured heat-exchanging device 103 of the embodiment produces the effect similar to the structure described in the first exemplary embodiment.

### Fifth Exemplary Embodiment

A fifth exemplary embodiment according to the present disclosure is described. Although the first exemplary embodiment described an example of a heat-exchanging device having a condenser and a liquid tank, the heat-exchanging device may include a subcool condenser. The embodiment describes heat-exchanging device 104 having condenser 110, liquid tank 120, and subcool condenser 150 (as an example of the component section).

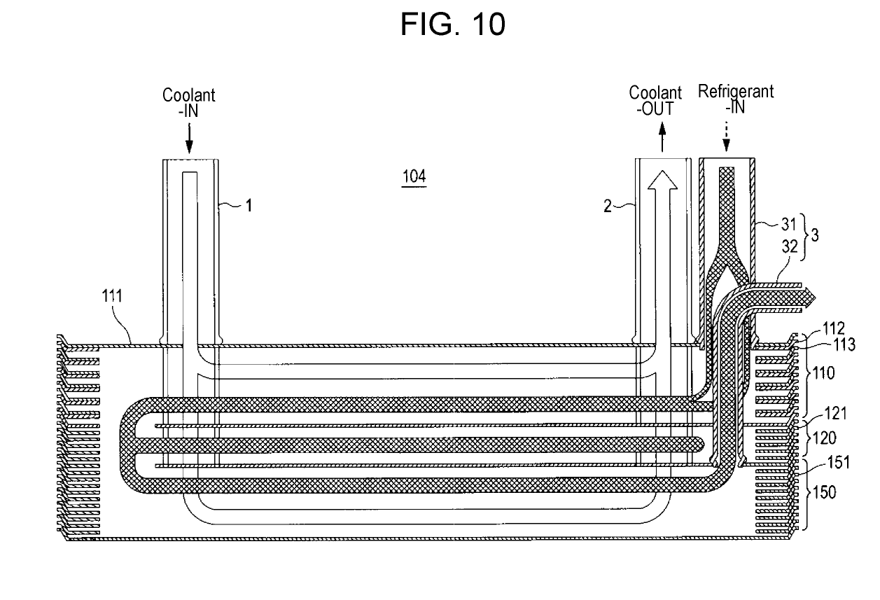

The structure of heat-exchanging device 104 of the embodiment is described with reference to FIG. 10.

FIG. 10 is a cross-sectional view showing the structure of heat-exchanging device 104 of the embodiment. FIG. 10 also shows flowing directions of the refrigerant and the coolant in heat-exchanging device 104. Apart of each plate is omitted in FIG. 10. In FIG. 10, like parts are identified by the same reference marks as in FIG. 4, and the detailed description thereof is omitted.

The structure of FIG. 10 differs from that of FIG. 4 in that pipe 1 for coolant-IN is oppositely disposed from pipe 2 for coolant-OUT and pipe 3 for refrigerant-IN/OUT.

As shown in FIG. 10, heat-exchanging device 104 has subcool condenser 150 under liquid tank 120. Subcool condenser 150 is formed of a plurality of subcool-condenser plates 151 stacked one on another. Subcool-condenser plates 151 are substantially equal in dimension in the stacking direction and are equal in size and in outer shape. Each of the plurality of subcool-condenser plates 151 is substantially equal to each of condenser plates 111 through 113 and each of liquid-tank plates 121 in dimensions in the stacking direction. In addition, each of the plurality of subcool-condenser plates 151 is equal to each of condenser plates 111 through 113 and each of liquid-tank plates 121 in profile line and dimensions orthographically projected on a plane perpendicular to the stacking direction.

The plurality of subcool-condenser plates 151 is continuously stacked with the plurality of condenser plates 111 through 113 and the plurality of liquid-tank plates 121. That is, subcool condenser 150 is located under liquid tank plates 121. Liquid tank 120 of the embodiment has no liquid-tank plate 122 shown in FIG. 3 at the bottom.

In subcool condenser 150, a refrigerant passage through which the low-pressure refrigerant flows and a coolant passage through which the coolant that applies the low-pressure refrigerant with heat flows are disposed between the plurality of subcool-condenser plates 151 of the stacked structure. Specifically, differently-shaped subcool-condenser plates 151 (for example, one is equal to condenser plate 112 in shape, and the other is equal to condenser plate 113 in shape) are alternately stacked, thereby the refrigerant passage and the coolant passage are alternately formed between the plurality of subcool-condenser plates 151. The refrigerant and the coolant, without being mixed, pass through the refrigerant passage and the refrigerant passage, respectively, in the same direction. In subcool condenser 150, as described above, the refrigerant flows through the refrigerant passage and the coolant flows through the coolant passage, thus the refrigerant and the coolant exchange heat therebetween, and the refrigerant is further compressed.

At the design phase of heat-exchanging device 104, the number of alternately stacked subcool-condenser plates 151 of a different shape determines the volume (efficiency in heat exchange) of subcool condenser 150.

FIG. 10 shows an example where the refrigerant and the coolant flow the refrigerant passage and the coolant passage, respectively, in the same direction, but it is not limited to; the refrigerant and the coolant may flow the refrigerant passage and the coolant passage, respectively, in opposite directions from each other.

Heat-exchanging device 104 of the embodiment is thus structured.

In heat-exchanging device 104 with the structure above, the coolant and the refrigerant flow as follows.

As shown in FIG. 10, the coolant fed from pipe 1 branches into condenser 110 and subcool condenser 150. The coolant that has passed through condenser 110 and the coolant that has passed through subcool condenser 150 join together and the joined coolant is discharged from pipe 2.

As shown in FIG. 10, the refrigerant, which has flown from outer pipe 31, flows through the inside of outer pipe 31 but the outside of inner pipe 32. After passing through condenser 110, the refrigerant branches into liquid tank 120 and subcool condenser 150. The refrigerant that has passed through subcool condenser 150 flows through the inside of inner pipe 32 and is discharged from pipe 32.

Heat-exchanging device 104 of the embodiment, as described above, has condenser 110, liquid tank 120, and subcool condenser 150. Such structured heat-exchanging device 104 of the embodiment produces the effect similar to the structure described in the first exemplary embodiment.

The descriptions above are on heat-exchanging devices 100 through 104 in which the pipe for refrigerant-IN and the pipe for refrigerant-OUT are integrally formed.

In contrast, the descriptions hereinafter are on heat-exchanging devices 200, 202, and 203 in which a pipe for refrigerant-IN and a pipe for refrigerant-OUT are individually formed.

### Sixth Exemplary Embodiment

A sixth exemplary embodiment of the present disclosure is described.

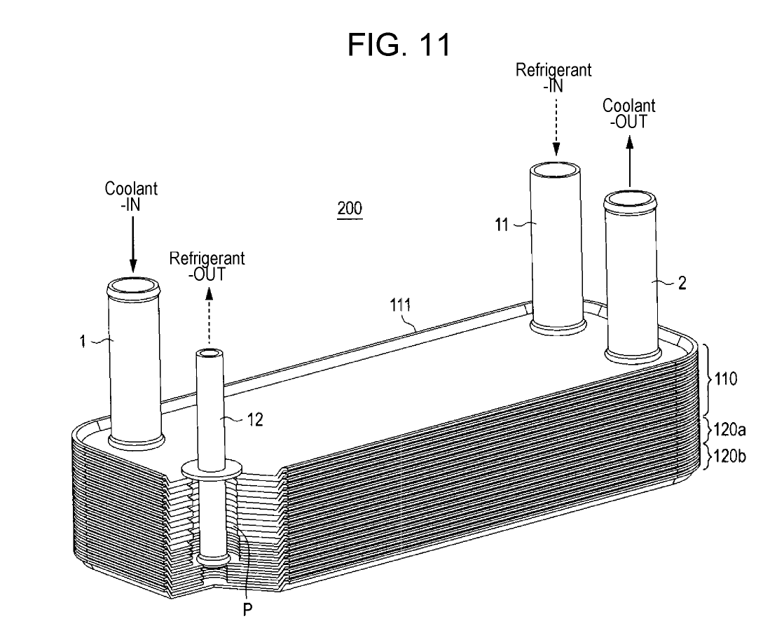

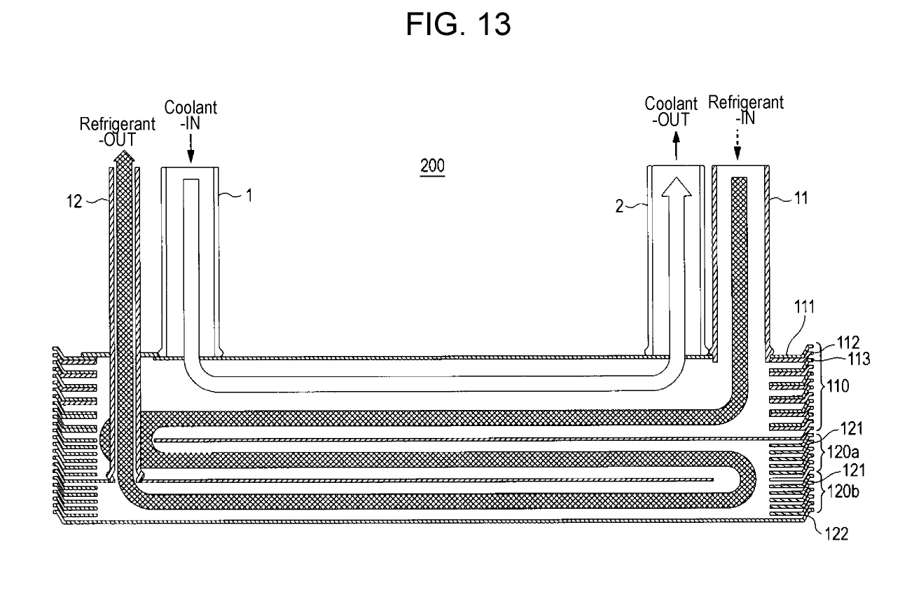

The structure of heat-exchanging device 200 of the embodiment is described with reference to FIG. 11 though FIG. 13.

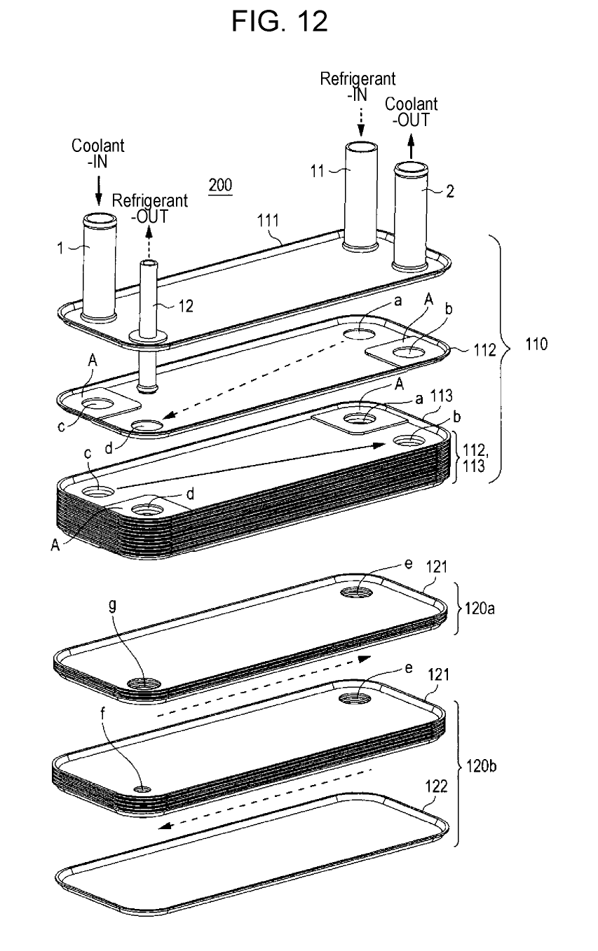

FIG. 11 is a perspective view showing the structure of heat-exchanging device 200. FIG. 11 also shows a cross section of pipe 12. FIG. 12 is a perspective view showing the state where the plurality of plates forming heat-exchanging device 200 of FIG. 11 is disassembled. FIG. 13 is a cross-sectional view showing the structure of heat-exchanging device 200 of FIG. 11. FIG. 13 also shows flowing directions of refrigerant and coolant in heat-exchanging device 200. A part of each plate is omitted in FIG. 13. In FIGS. 11 to 13, like parts are identified by the same reference marks as in FIGS. 2 to 4, respectively, and the detailed description thereof is omitted.

As shown in FIG. 11 through FIG. 13, in heat-exchanging device 200, liquid tank 120a (as an example of the component section) and liquid tank 120b (as an example of the component section) are disposed under condenser 110. Liquid tank 120a is formed of a plurality of liquid-tank plates 121 stacked one on another. Liquid tank 120b, which is also formed of a plurality of liquid-tank plates 121 stacked one on another, has liquid-tank plate 122 at the bottom.

As shown in FIG. 12, each of liquid-tank plates 121 that form liquid tank 120a is provided with opening ‘g’. The diameter of opening ‘g’ is the same with that of opening ‘d’ of each of condenser plates 111 through 113. The flow passage formed by the plurality of openings ‘g’ communicates the flow passage formed by the plurality of openings A′, thereby forming flow-passage P in which refrigerant flows through condenser 110 and liquid tank 120a, as shown in FIG. 11.

As shown in FIG. 11 and FIG. 12, in addition to pipe 1 for coolant-IN and pipe 2 for coolant-OUT, pipe 11 and pipe 12 are connected to condenser plate 111. The high-temperature and high-pressure refrigerant compressed by compressor 30 flows through pipe 11 into condenser 110. After performing heat exchange in condenser 110, the refrigerant undergoes vapor-liquid separation in liquid tanks 120a and 120b. Through pipe 12, the refrigerant is discharged to expansion valve 20. In FIG. 12, a broken-line arrow shows the flowing direction of refrigerant, and a solid-line arrow shows the flowing direction of coolant.

As shown in FIG. 12, the outer diameter of pipe 12 is smaller than the diameter of openings ‘d’ and ‘g’. As shown in FIG. 11, pipe 12 is disposed in flow passage P formed of openings ‘d’ and ‘g’. That is, flow passage P has a double-pipe structure having a flow passage formed of the inside of flow passage P but the outside of pipe 12 and a flow passage formed of the inside of pipe 12.

The flow passage that runs the inside of flow passage P but the outside of pipe 12 serves as the flow passage in which the refrigerant fed from pipe 11 flows through condenser 110 and liquid tank 120a in the vertically downward direction. The flow passage that runs the inside of pipe 12 serves as the flow passage in which the refrigerant that has passed condenser 110 and liquid tanks 120a, 120b flows through condenser 110 and liquid tank 120 in the vertically upward direction.

Heat-exchanging device 200 is thus structured.

In heat-exchanging device 200 with the structure above, the coolant and the refrigerant flow as follows.

As shown in FIG. 13, the coolant fed from pipe 1 passes through condenser 110 and is discharged from pipe 2.

As shown in FIG. 13, the refrigerant fed from pipe 11 flows through condenser 110 and then the outside of pipe 12 into liquid tank 120a. After passing through liquid tank 120a, the refrigerant flows through liquid tank 120b and the inside of pipe 12 and is discharged from pipe 12 into expansion valve 20.

As described above, according to heat-exchanging device 200 of the embodiment, condenser 110 and liquid tank 120a have flow passage P formed of openings ‘d’ and ‘g’, and high-pressure refrigerant flows therethrough. Pipe 12 (as an example of the first pipe) is disposed inside flow passage P. The outer diameter of pipe 12 is smaller than the diameter of openings ‘d’ and ‘g’. Pipe 12 is disposed in flow passage P so that the refrigerant that has flown into condenser 110 flows inside flow passage P but outside pipe 12; at the same time, the refrigerant that has passed through liquid tank 120b flows inside pipe 12.

As described in the first exemplary embodiment, in a conventional heat-exchanging device having condenser 110 and a liquid tank, each plate has to be provided with three openings to form the flow passage for refrigerant. In contrast, according to the embodiment, pipe 12 is disposed in flow passage P formed of openings ‘d’ and ‘g’. The structure allows the refrigerant fed from the compressor to flow the inside of flow passage P but the outside of pipe 12 and the refrigerant that has passed through the refrigerant passage of the liquid tank to flow the inside of pipe 12. By virtue of the structure of the embodiment, the number of the openings for forming the refrigerant passages is decreased to two (i.e., opening ‘a’ and opening ‘d’ in condenser plates 111 through 113, and opening ‘e’ and opening ‘g’ or ‘f’ in liquid-tank plate 121).

According to the embodiment, the openings in each plate can be decreased in number, thereby ensuring strength of the plates. That is, the structure enhances durability of the heat-exchanging device.

As described above, the structure of the embodiment achieves decrease in number of the openings to be formed in each plate. When each opening is disposed in the short-side direction of the plate, as shown in FIG. 11 and FIG. 12, the structure allows the plate to have a decreased length of the short side, contributing to a downsized structure of a heat-exchanging device.

### Seventh Exemplary Embodiment

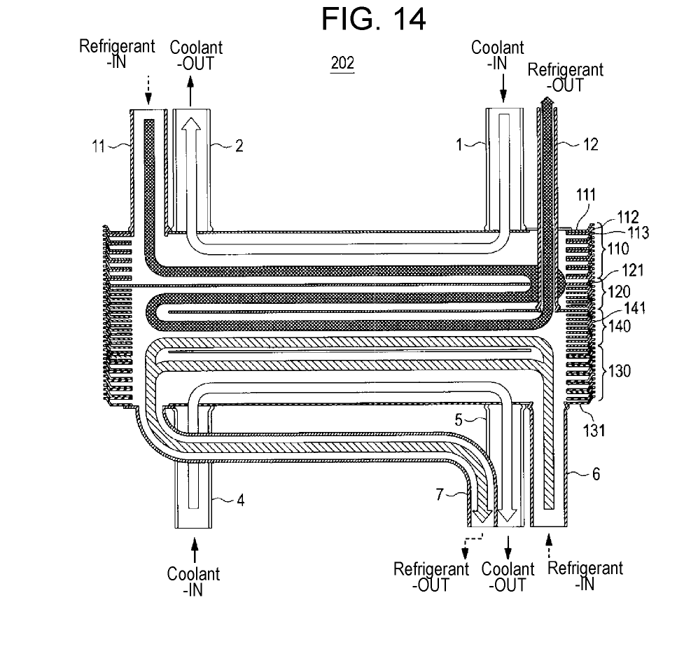

A seventh exemplary embodiment of the present disclosure is described with reference to FIG. 14. FIG. 14 is a cross-sectional view showing the structure of heat-exchanging device 202 of the embodiment.

As shown in FIG. 14, heat-exchanging device 202 has a structure basically the same as that of heat-exchanging device 102 (see FIG. 7) described in the third exemplary embodiment, except that condenser plate 111 has pipe 11 and pipe 12 instead of pipe 3 shown in FIG. 7. In FIG. 14, like parts are identified by the same reference marks as in FIG. 7, and the detailed description thereof is omitted.

In heat-exchanging device 202, the coolant and the refrigerant flow as follows.

As shown in FIG. 14, the coolant fed from pipe 1 passes through condenser 110 and is discharged from pipe 2.

As shown in FIG. 14, the refrigerant fed from pipe 11 passes through condenser 110 and flows through the outside of pipe 12 into liquid tank 120. After passing through liquid tank 120, the refrigerant passes through intermediate heat-exchanger 140 then flows inside pipe 12 and is discharged from pipe 12 into expansion valve 20.

As shown in FIG. 14, the coolant fed from pipe 4 passes through evaporator 130 and is discharged from pipe 5.

As shown in FIG. 14, the refrigerant fed from pipe 6 branches into evaporator 130 and intermediate heat-exchanger 140. The refrigerant that has passed through evaporator 130 and the refrigerant that has passed through intermediate heat-exchanger 140 join again, and the joined refrigerant is discharged from pipe 7 to compressor 30.

Heat-exchanging device 202 of the embodiment, as described above, has condenser 110, liquid tank 120, evaporator 130, and intermediate heat-exchanger 140. Such structured heat-exchanging device 202 of the embodiment produces the effect similar to the structure described in the sixth exemplary embodiment above.

### Eighth Exemplary Embodiment

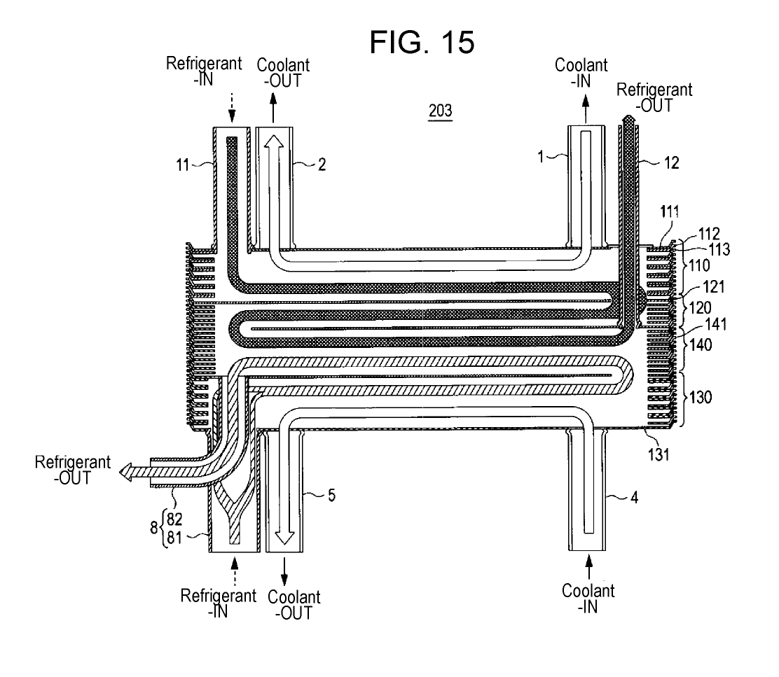

An eighth exemplary embodiment of the present disclosure is described with reference to FIG. 15. FIG. 15 is a cross-sectional view showing the structure of heat-exchanging device 203 of the embodiment.

As shown in FIG. 15, heat-exchanging device 203 has a structure basically the same as that of heat-exchanging device 103 (see FIG. 9) described in the fourth exemplary embodiment, except that condenser plate 111 has pipe 11 and pipe 12 instead of pipe 3 shown in FIG. 9. In addition, the structure of FIG. 15 differs from that of FIG. 9 in that pipe 1 for coolant-IN is oppositely disposed from pipe 2 for coolant-OUT. In FIG. 15, like parts are identified by the same reference marks as in FIG. 9, and the detailed description thereof is omitted.

In heat-exchanging device 203, the coolant and the refrigerant flow as follows.

As shown in FIG. 15, the coolant fed from pipe 1 passes through condenser 110 and is discharged from pipe 2.

As shown in FIG. 15, the refrigerant fed from pipe 11 passes through condenser 110 and flows outside pipe 12 into liquid tank 120. After passing through liquid tank 120, the refrigerant passes through intermediate heat-exchanger 140 then flows inside pipe 12 and is discharged from pipe 12 into expansion valve 20.

As shown in FIG. 15, the coolant fed from pipe 4 passes through evaporator 130 and is discharged from pipe 5.

As shown in FIG. 15, the refrigerant that has flown from outer pipe 81 flows inside outer pipe 81 but outside inner pipe 82 and then passes through evaporator 130 into intermediate heat-exchanger 140. After passing through intermediate heat-exchanger 140, the refrigerant flows inside inner pipe 82 and is discharged from inner pipe 82 into compressor 30.

Heat-exchanging device 203 of the embodiment, as described above, has condenser 110, liquid tank 120, evaporator 130, and intermediate heat-exchanger 140. Such structured heat-exchanging device 203 of the embodiment produces the effect similar to the structure described in the sixth exemplary embodiment above.

### Ninth Exemplary Embodiment

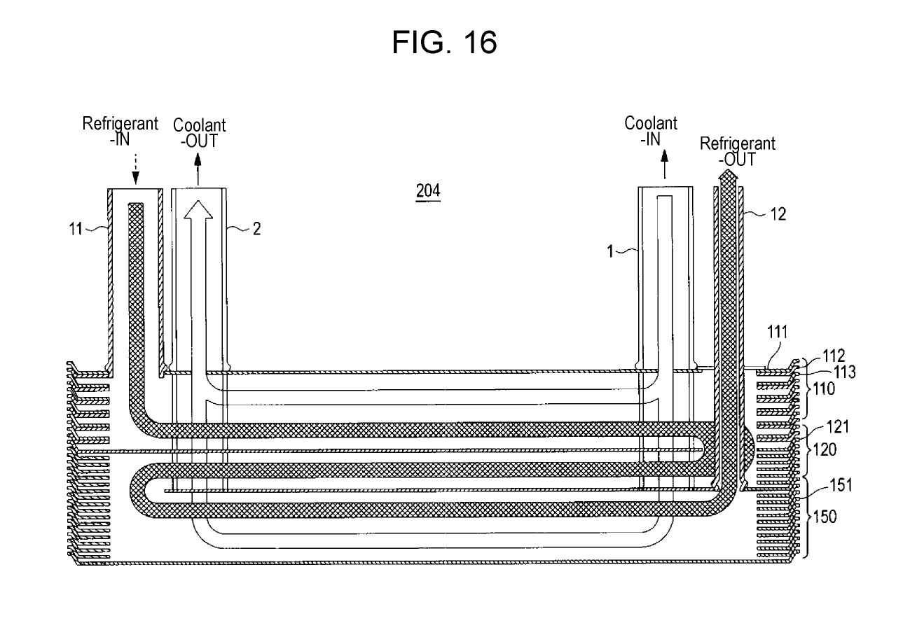

A ninth exemplary embodiment of the present invention is described with reference to FIG. 16. FIG. 16 is a cross-sectional view showing the structure of heat-exchanging device 204 of the embodiment.

As shown in FIG. 16, heat-exchanging device 204 has a structure basically the same as that of heat-exchanging device 104 (see FIG. 10) described in the fifth exemplary embodiment, except that condenser plate 111 has pipe 11 and pipe 12 instead of pipe 3 shown in FIG. 10. In addition, the structure of FIG. 16 differs from that of FIG. 10 in that pipe 1 for coolant-IN is oppositely disposed from pipe 2 for coolant-OUT. In FIG. 16, like parts are identified by the same reference marks as in FIG. 10, and the detailed description thereof is omitted.

In heat-exchanging device 204, the coolant and the refrigerant flow as follows.

As shown in FIG. 16, the coolant fed from pipe 1 branches into condenser 110 and subcool condenser 150. The coolant that has passed through condenser 110 and the coolant that has passed through subcool condenser 150 join again and the joined coolant is discharged from pipe 12.

As shown in FIG. 16, the refrigerant fed from pipe 11 passes through condenser 110 and flows outside pipe 12 into liquid tank 120. After passing through liquid tank 120, the refrigerant passes through subcool condenser 150 then flows inside pipe 12 and is discharged from pipe 12.

Heat-exchanging device 204 of the embodiment, as described above, has condenser 110, liquid tank 120, and subcool condenser 150. Such structured heat-exchanging device 204 of the embodiment produces the effect similar to the structure described in the sixth exemplary embodiment above.

The description above is on heat-exchanging devices 200, 202, and 203 each in which the pipe for refrigerant-IN and the pipe for refrigerant-OUT are individually formed.

The structures of the first through the ninth exemplary embodiments of the present disclosure have been described so far. However, the present disclosure is not limited to the structures described in the first through ninth exemplary embodiments above, allowing various modifications without departing from the spirit and scope of the disclosure. Hereinafter, modification examples will be described.

For example, the plurality of plates forming the heat-exchanging device in the first through ninth exemplary embodiments may differ from each other in shape of visible outline, in size, and in dimension in the stacking direction as long as the plates are stackable.

Further, for example, the components of the heat-exchanging device described in the first through ninth exemplary embodiments (for example, condenser 110, liquid tank 120, liquid tank 120a, liquid tank 120b, evaporator 130, intermediate heat-exchanger 140, and subcool condenser 150) are not necessarily stacked in the order described in the first through ninth exemplary embodiments.

Further, for example, the first through ninth exemplary embodiments have described a positioning state where the upper section of condenser 110 is directed vertically upward, whereas each lower section of liquid tank 120, liquid tank 120b, and evaporator 130 or subcool condenser 150 is directed vertically downward. However, the positioning state of the heat-exchanging device in use is not limited to the above.

Further, for example, the first through ninth exemplary embodiments have described an example where coolant (water) is employed for a heat carrier that exchanges heat with refrigerant, but it is not limited to; instead of coolant, oil or air may be used as the heat carrier.

Further, for example, the first through ninth exemplary embodiments have described an example where liquid tank 120, liquid tank 120a, or liquid tank 120b retain the refrigerant fed from condenser 110 by the flow passage formed of openings ‘e’, but it is not limited to. For example, a refrigerant-retaining section may be formed by forming each of the plurality of liquid-tank plates 121 into a window-flame shape having an opening in the center.

For example, the first through ninth exemplary embodiments have described that liquid tank 120, liquid tank 120a, and liquid tank 120b have a structure of a plurality of liquid-tank plates 121 stacked one on another. However, instead of the stacking structure of the plurality of plates, liquid tanks 120, 120a, 120b may be formed as an integrally-structured block having an accommodating space (corresponding to the refrigerant-retaining section) inside the structure. Furthermore, seen in the stacking direction, liquid tanks 120, 120a, 120b of a block-shaped structure may differ in shape of visible outline and in size from condenser 110, evaporator 130, intermediate heat-exchanger 140, or subcool condenser 150.

Further, for example, in the first through ninth exemplary embodiments, each of condenser 110, evaporator 130, intermediate heat-exchanger 140, or subcool condenser 150 may differ in shape of visible outline and in size, seen in the stacking direction, from each other.

Further, for example, the sixth through ninth exemplary embodiments have described that the inner diameter and the outer diameter of pipe 12 are smaller than those of pipe 11, but pipe 12 may be equal to pipe 11 in inner diameter and outer diameter.

Further, for example, in the third, fourth, and eighth exemplary embodiments, the pipe through which refrigerant flows into condenser 110 and the pipe through which the refrigerant is discharged after passing through condenser 110 and intermediate heat-exchanger 140 may not be formed as a double-pipe structure of outer pipe 31 and inner pipe 32.

Further, for example, the fourth and eighth exemplary embodiments have described an example in which outer pipe 81 and inner pipe 82 are integrally structured. However, they may be individually structured, like pipe 11 and pipe 12 shown in FIG. 13 through FIG. 16.

The present disclosure is applicable to air-conditioning and heating equipment mountable to vehicles.

What is claimed is:

1. A heat-exchanging device comprising a plate-stacked section of a plurality of plates continuously stacked one on another, the plate-stacked section comprising:
a condenser having a structure where a refrigerant passage through which a high-pressure refrigerant flows and a heat-carrier passage through which a heat carrier that absorbs heat from the high-pressure refrigerant flows are stacked one on another between a part of the plurality of plates; and
a component section having a structure where the refrigerant that has passed through the condenser flows between a part of the plurality of plates or via a part of the plates,
wherein,
in the condenser, openings respectively disposed in the plurality of plates forms a flow passage through which the refrigerant flows,
inside the flow passage, a first pipe having outer diameter smaller than a diameter of each of the openings is disposed, and
the first pipe is disposed such that the refrigerant that has flown into the condenser flows inside the flow passage but outside the first pipe and the refrigerant that has passed through the component section flows inside the first pipe.

2. The heat-exchanging device according to claim 1 further comprising a second pipe which carries the high-pressure refrigerant into the condenser,
wherein the first pipe and the second pipe are integrally provided.

3. The heat-exchanging device according to claim 2, wherein the component section includes an evaporator having a structure where a flow passage through which a low-pressure refrigerant flows and a flow passage through which a heat carrier that applies heat to the low-pressure refrigerant flows are stacked one on another between a part of the plurality of plates.

4. The heat-exchanging device according to claim 3,
wherein,
the component section includes an intermediate heat-exchanger that performs heat exchange between the high-pressure refrigerant that has passed through the condenser and the low-pressure refrigerant that has passed through the evaporator,
in the evaporator, a flow passage through which the low-pressure refrigerant flows is formed by openings respectively disposed in the plurality of plates,
inside the flow passage, a third pipe having an outer diameter smaller than a diameter of each of the openings is disposed, and
the third pipe is disposed such that the refrigerant that has flown into the evaporator flows inside the flow passage but outside the third pipe and the refrigerant that has passed through the intermediate heat-exchanger flows inside the third pipe.

5. The heat-exchanging device according to claim 4 further comprising a fourth pipe which carries the low-pressure refrigerant into the evaporator,
wherein the third pipe and the fourth pipe are integrally provided.

6. The heat-exchanging device according to claim 4 further comprising a fourth pipe which carries the low-pressure refrigerant into the evaporator,
wherein the third pipe and the fourth pipe are individually provided.

7. The heat-exchanging device according to claim 1 further comprising a second pipe which carries the high-pressure refrigerant into the condenser,
wherein the first pipe and the second pipe are independently provided.

8. The heat-exchanging device according to claim 1, wherein the component section includes at least one liquid tank which retains the high-pressure refrigerant between a part of the plurality of plates or via a part of the plates.

9. The heat-exchanging device according to claim 1, wherein the component section includes an intermediate heat-exchanger having a structure where a flow passage through which the high-pressure refrigerant flows and a flow passage through which a low-pressure refrigerant flows are stacked one on another between a part of the plurality of plates.

10. The heat-exchanging device according to claim 1, wherein the component section includes a subcool condenser having a structure where a flow passage through which the high-pressure refrigerant flows and a flow passage through which a heat carrier that further absorbs heat from the high-pressure refrigerant flows are stacked one on another between a part of the plurality of plates.

11. The heat-exchanging device according to claim 1, wherein the component section includes an evaporator having a structure where a flow passage through which a low-pressure refrigerant flows and a flow passage through which a heat carrier that applies heat to the low-pressure refrigerant flows are stacked one on another between a part of the plurality of plates.
